(19) United States
(12) Patent Application Publication
(10) Pub. No.: US 2018/0329487 A1
(43) Pub. Date: Nov. 15, 2018

(54) INFORMATION PROCESSING METHOD, COMPUTER AND PROGRAM

(71) Applicant: COLOPL, Inc., Tokyo (JP)

(72) Inventors: Masaya AOYAMA, Tokyo (JP); Shuhei TERAHATA, Tokyo (JP)

(21) Appl. No.: 15/976,953

(22) Filed: May 11, 2018

(30) Foreign Application Priority Data
May 12, 2017 (JP) 2017-095610

(51) Int. Cl. G06F 3/01; G06T 19/00; G06T 15/20

(52) U.S. Cl. CPC G06F 3/012; G06T 15/20; G06T 19/003

(57) ABSTRACT

A method includes defining a virtual space, the virtual space containing a virtual viewpoint, an operation object, and a target object. The method further includes defining a visual field in the virtual space in accordance with a position of the virtual viewpoint in the virtual space. The method further includes generating a visual-field image corresponding to the visual field. The method further includes displaying the visual-field image on the HMD. The method further includes detecting a position of a part of a body of a user associated with the HMD. The method further includes determining that a state of the part of the body satisfies a first condition. The method further includes determining, on condition that the first condition is satisfied, that a state of the part of the body satisfies a second condition different from the first condition, the second condition including a condition that the operation object has yet to select the target object. The method further includes setting, in accordance with the first condition being satisfied and the second condition failing to be satisfied, a motion of the operation object to a first mode. The method further includes setting, in accordance with the first condition being satisfied and the second condition being satisfied, the motion of the operation object to a second mode. The method further includes moving, on condition that the first mode is set, the operation object in the virtual space in accordance with a motion of the part of the body without changing a state of the virtual viewpoint in the virtual space. The method further includes moving, on condition that the second mode is set, the operation object in the virtual space in accordance with the motion of the part of the body, and changing the state of the virtual viewpoint in the virtual space in accordance with the motion of the part of the body or a motion of the operation object. The method further includes updating the visual-field image in accordance with the state of the virtual viewpoint having been changed.

This disclosure relates to an information processing method, a computer, and a program.

### BACKGROUND

In Patent Document 1, there is described a technology enabling a virtual experience in a virtual space to be enjoyed from various viewpoints by moving the viewpoint in the virtual space.

### PATENT DOCUMENT

[Patent Document 1] Japanese Patent No. 5869177

### SUMMARY

According to at least one embodiment of this disclosure, there is provided a method including: defining a virtual space, the virtual space including a virtual viewpoint, an operation object, and a target object; defining a visual field in the virtual space in accordance with a position of the virtual viewpoint in the virtual space; generating a visual-field image corresponding to the visual field; displaying the visual-field image on the HMD; detecting a position of a part of a body of a user associated with the HMD; determining that a state of the part of the body satisfies a first condition; determining, on condition that the first condition is satisfied, that a state of the part of the body satisfies a second condition different from the first condition, the second condition including a condition that the operation object yet to select the target object; setting, in accordance with the first condition being satisfied and the second condition failing to be satisfied, a motion of the operation object to a first mode; setting, in accordance with the first condition being satisfied and the second condition being satisfied, the motion of the operation object to a second mode; moving, on condition that the first mode is set, the operation object in the virtual space in accordance with a motion of the part of the body without changing a state of the virtual viewpoint in the virtual space; moving, on condition that the second mode is set, the operation object in the virtual space in accordance with the motion of the part of the body, and changing the state of the virtual viewpoint in the virtual space in accordance with the motion of the part of the body or a motion of the operation object; and updating the visual-field image in accordance with the state of the virtual viewpoint having been changed.

Other features and advantages of this disclosure are made clear from the following description of embodiments of this disclosure, the attached drawings, and the description of the appended claims.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

FIG. 15 A flowchart of general processing for displaying on a display an image of the virtual space in which the user is to be immersed according to at least one embodiment of this disclosure.

FIG. 16 A flowchart of a method according to at least one embodiment of this disclosure.

FIG. 17 A schematic diagram of an expected mode of a game according to at least one embodiment of this disclosure.

FIG. 18 A diagram of an example of a field-of-view image generated by processing according to at least one embodiment of this disclosure.

FIG. 19 A diagram of an example of a field-of-view image generated by processing according to at least one embodiment of this disclosure.

FIG. 20 A diagram of an example of a field-of-view image generated by processing according to at least one embodiment of this disclosure.

FIG. 21 A diagram of an example of a field-of-view image generated by processing according to at least one embodiment of this disclosure.

FIG. 22 A diagram of an example of a field-of-view image generated by processing according to at least one embodiment of this disclosure.

FIG. 23 A schematic diagram of an example of processing according to at least one embodiment of this disclosure.

FIG. 24 A diagram of an example of a field-of-view image generated by processing according to at least one embodiment of this disclosure.

FIG. 25 A schematic diagram of an example of processing according to at least one embodiment of this disclosure.

FIG. 26 A diagram of an example of a field-of-view image in which visual information is reduced according to at least one embodiment of this disclosure.

FIG. 27 A graph of an example of a relationship between a rotation angle of a virtual viewpoint and time according to at least one embodiment of this disclosure.

FIG. 28 A diagram of an example of a field-of-view image generated by processing according to at least one embodiment of this disclosure.

FIG. 29 A diagram of an example of a field-of-view image generated by processing according to at least one embodiment of this disclosure.

FIG. 30 A schematic diagram of an example of processing according to at least one embodiment of this disclosure.

FIG. 31 A diagram of an example of a field-of-view image generated by processing according to at least one embodiment of this disclosure.

### DETAILED DESCRIPTION

### Description of Embodiments of this Disclosure

First, there are listed examples of configurations of exemplary embodiments of this disclosure. A method, a computer, and a program according to the embodiments of this disclosure may be configured as follows.

(Item 1)

An information processing method to be executed in a system including a head-mounted device and a sensor configured to detect a position of a part of a body other than a head of a user, the information processing method including:

identifying virtual space data defining a virtual space containing an operation object associated with the part of the body and at least one target object, the operation object being movable in at least two motion modes including a normal mode and a selection mode;

identifying a virtual viewpoint in the virtual space;

generating a field-of-view image in accordance with the virtual space data, the virtual viewpoint, and a direction of the head-mounted device;

moving the operation object in the normal mode in the virtual space in accordance with a motion of the part of the body;

switching, when a state of the part of the body satisfies a predetermined condition, a motion mode of the operation object to the selection mode;

moving, when none of the at least one target object is selected by the operation object when the motion mode has been switched to the selection mode, the virtual viewpoint based on the motion of the part of the body or a motion of the operation object during continuation of the selection mode; and

outputting the field-of-view image generated based on the virtual viewpoint to a display associated with the head-mounted device.

(Item 2)

The method according to Item 1, wherein the motion of the part of the body includes a position of the part of the body.

(Item 3)

The method according to Item 1 or 2, further including moving, when the at least one target object is selected by the operation object when the motion mode has been switched to the selection mode, the at least one target object based on the motion of the part of the body or the motion of the operation object during the continuation of the selection mode.

(Item 4)

The method according to any one of Items 1 to 3,

wherein the part of the body includes a right hand and a left hand,

wherein the operation object includes a right hand object and a left hand object, and

wherein the method further includes moving the virtual viewpoint based on a motion of the right hand and/or the left hand, or a motion of the right hand object and/or the left hand object.

(Item 5)

The method according to Item 4, further including moving, when a motion mode of the right hand object and a motion mode of the left hand object are both the selection mode, and when a motion of the right hand and a motion of the left hand are detected, the virtual viewpoint based on the motion of a hand that has moved first among the right hand and the left hand or based on a motion of the operation object corresponding to the hand that has moved first.

(Item 6)

The method according to anyone of Items 1 to 5, further including gradually increasing a movement speed of the virtual viewpoint in the selection mode when a continuous motion of the part of the body or the operation object is detected.

(Item 7)

The method according to Item 6, further including setting a movement speed of the virtual viewpoint corresponding to one motion included in the continuous motion to be faster than a movement speed of the virtual viewpoint corresponding to a motion performed before the one motion.

(Item 8)

The method according to Item 6 or 7, further including increasing the movement speed of the virtual viewpoint when the motion included in the continuous motion is a motion at a constant speed or higher and/or when a plurality of motions included in the continuous motion are performed within a time interval smaller than a fixed time interval.

(Item 9)

The method according to anyone of Items 6 to 8, further including gradually increasing, when one motion included in the continuous motion is a motion at a constant speed or higher and/or a motion of a certain distance or further, the movement speed of the virtual viewpoint during a period in which the one motion is being performed.

(Item 10)

The method according to anyone of Items 1 to 9, further including reducing, or setting to zero, the movement speed of the virtual viewpoint when an angle of the motion of the part of the body or the motion of the operation object with respect to a roll axis of a visual field is more than half of a viewing angle.

(Item 11)

The method according to any one of Items 1 to 10, further including reducing, or setting to zero, based on at least one component of a direction orthogonal to a roll axis of the visual field among the motion of the part of the body or the motion of the operation object, a component in the direction of a movement speed of the virtual viewpoint.

(Item 12)

The method according to Item 4 or 5, further including rotating, when both the motion mode of the right hand object and the motion mode of the left hand object are the selection mode, when none of the at least one target object is selected, and when a motion of enclosing a similarly shaped region in a similar direction by both the right hand and the left hand is detected, the virtual viewpoint based on the motion.

(Item 13)

The method according to Item 12, further including rotating, when the motion of enclosing the similarly shaped region is inclined with respect to a horizontal plane, the virtual viewpoint based on the motion projected onto the horizontal plane.

(Item 14)

The method according to Item 12 or 13, further including reducing visual information on the field-of-view image when rotating the virtual viewpoint.

(Item 15)

The method according to any one of Items 12 to 14, wherein the rotating of the virtual viewpoint includes rotating the virtual viewpoint at a first speed and rotating the virtual viewpoint at a second speed, which is slower than the first speed, or is zero.

(Item 16)

The method according to any one of Items 4, 5, and 12 to 15, further including reducing or increasing, when both the motion mode of the right hand object and the motion mode of the left hand object are the selection mode, when none of the at least one target object is selected, and when a motion in which the right hand and the left hand are approaching each other is detected, a range of the virtual space contained in the field-of-view image.

(Item 17)

The method according to any one of Items 4, 5, and 12 to 15, further including reducing or increasing, when both the motion mode of the right hand object and the motion mode of the left hand object are the selection mode, when none of the at least one target object is selected, and when a motion in which the right hand and the left hand moving away from each other is detected, a range of the virtual space contained in the field-of-view image.

(Item 18)

The method according to Item 16 or 17, wherein the reducing or increasing of the range of the virtual space contained in the field-of-view image includes changing a size of a virtual camera in the virtual space without changing a position of the virtual viewpoint.

(Item 19)

A program for executing the method of any one of Items 1 to 18 on a processor.

(Item 20)

A computer, including:

a processor; and

a memory,

the computer being configured to execute the method of any one of Item 1 to 18 under control of the processor.

(Item 21)

A computer to be used in a system including a head-mounted device and a sensor configured to detect a position of a part of a body other than a head of a user, the computer including a processor,

the processor being configured to:

identify virtual space data defining a virtual space containing an operation object associated with the part of the body and at least one target object, the operation object movable in at least two motion modes including a normal mode and a selection mode,

identify a virtual viewpoint in the virtual space;

generate a field-of-view image in accordance with the virtual space data, the virtual viewpoint, and a direction of the head-mounted device;

move the operation object in the normal mode in the virtual space in accordance with a motion of the part of the body;

switch, when a state of the part of the body satisfies a predetermined condition, a motion mode of the operation object to the selection mode;

move, when none of the at least one target object is selected by the operation object when the motion mode has been switched to the selection mode, the virtual viewpoint based on the motion of the part of the body or a motion of the operation object during continuation of the selection mode; and

output the field-of-view image generated based on the virtual viewpoint to a display associated with the head-mounted device.

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

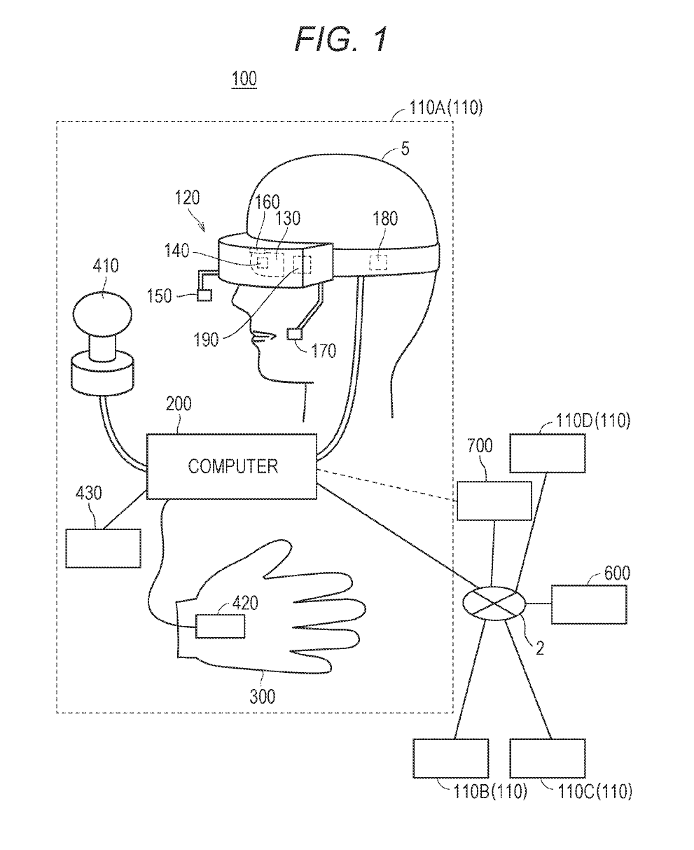

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

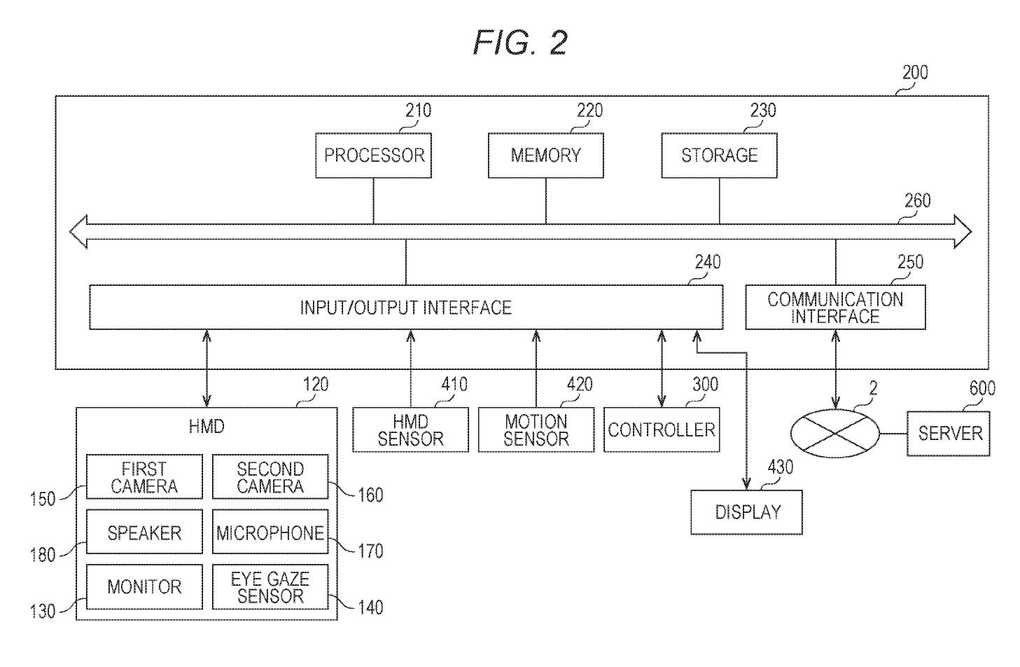

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

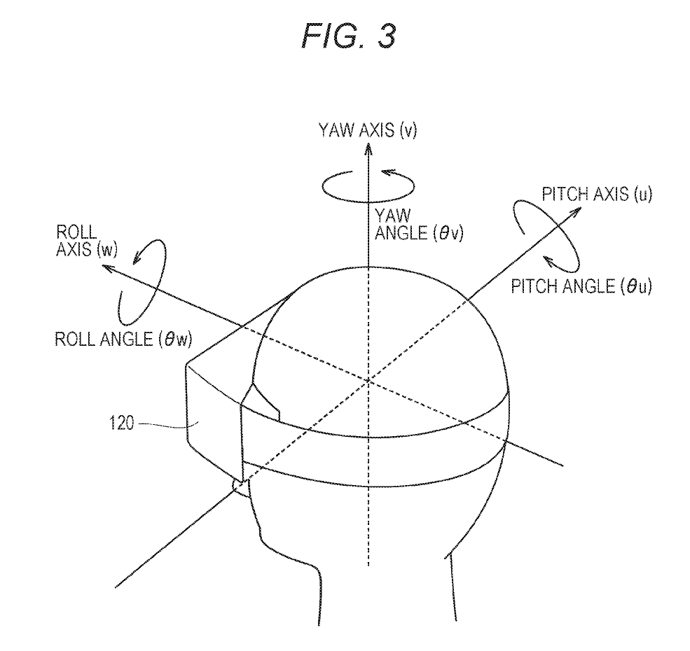

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

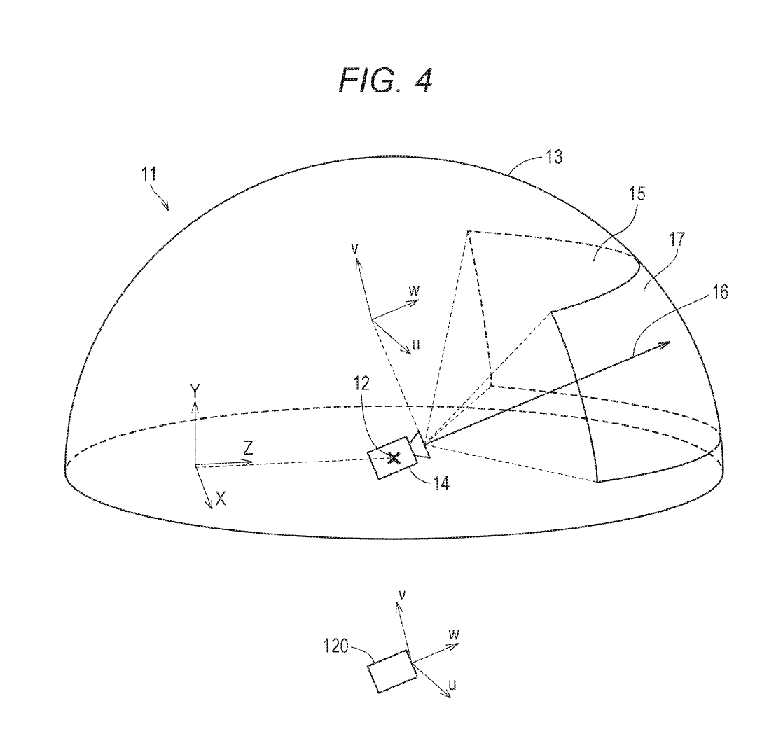

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

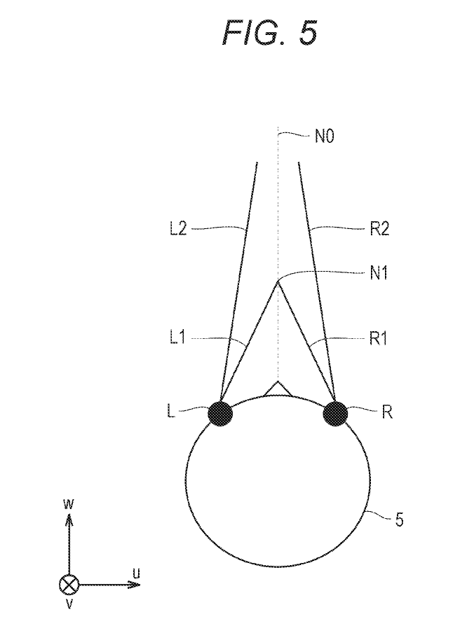

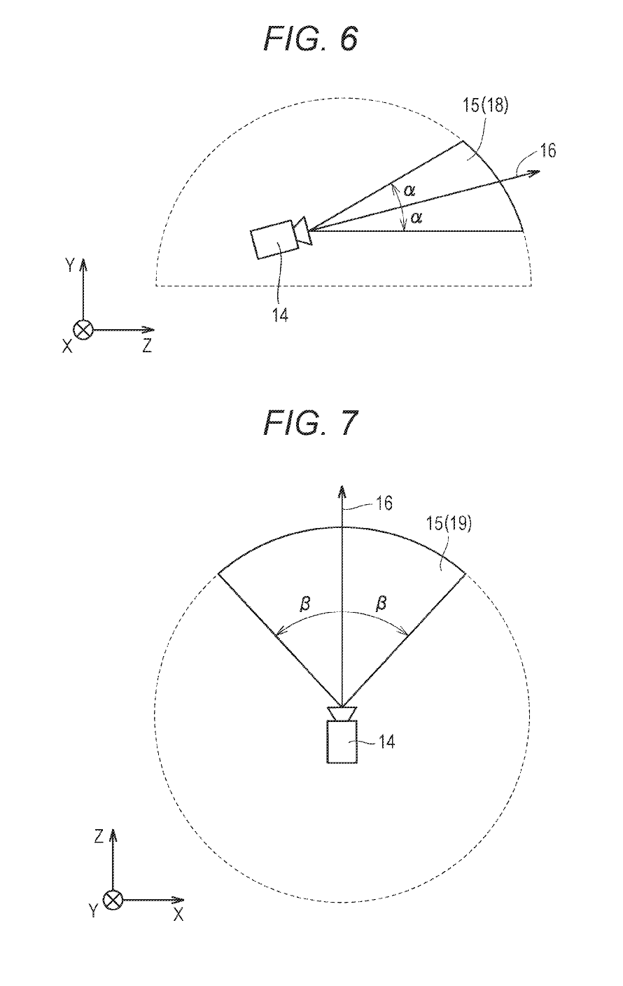

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth P from the reference line of sight 16 serving as the center in the virtual space 11 as the region 19. The polar angle α and R are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to apart of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

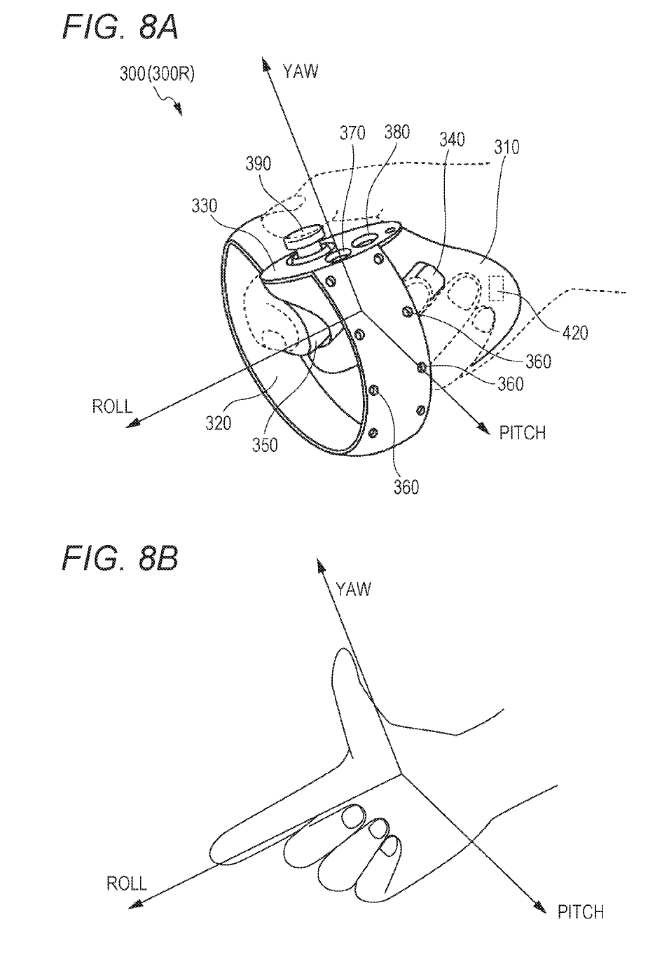

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

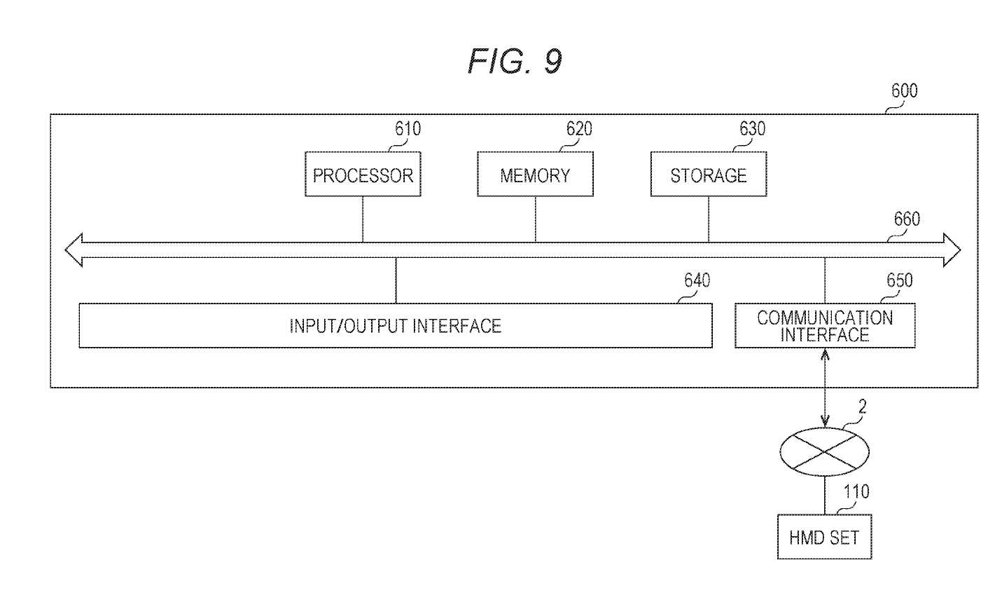

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

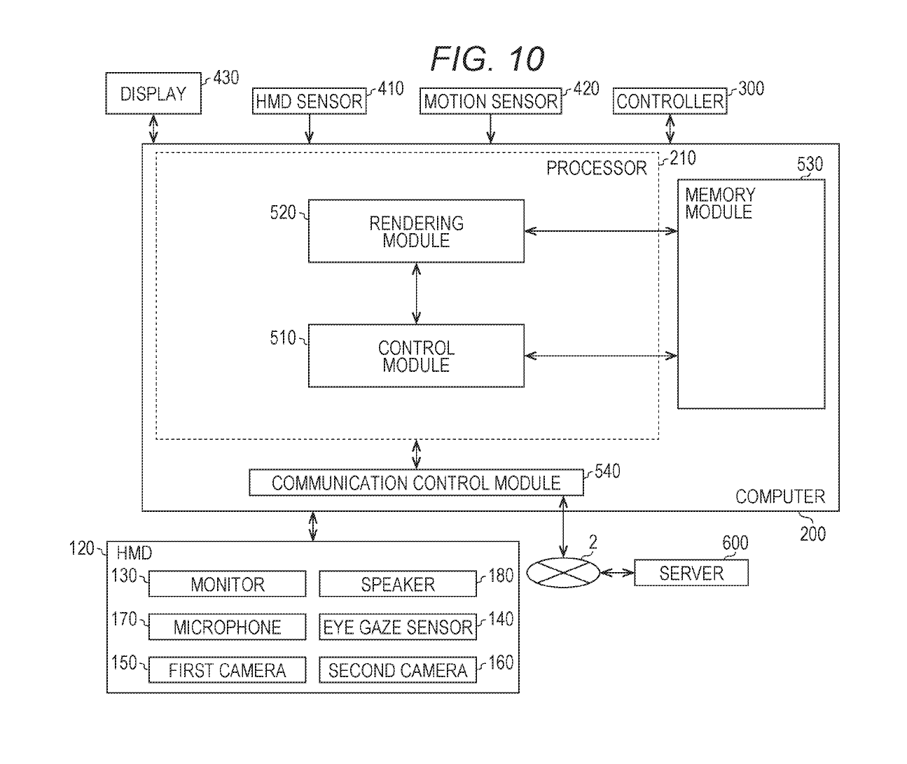

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

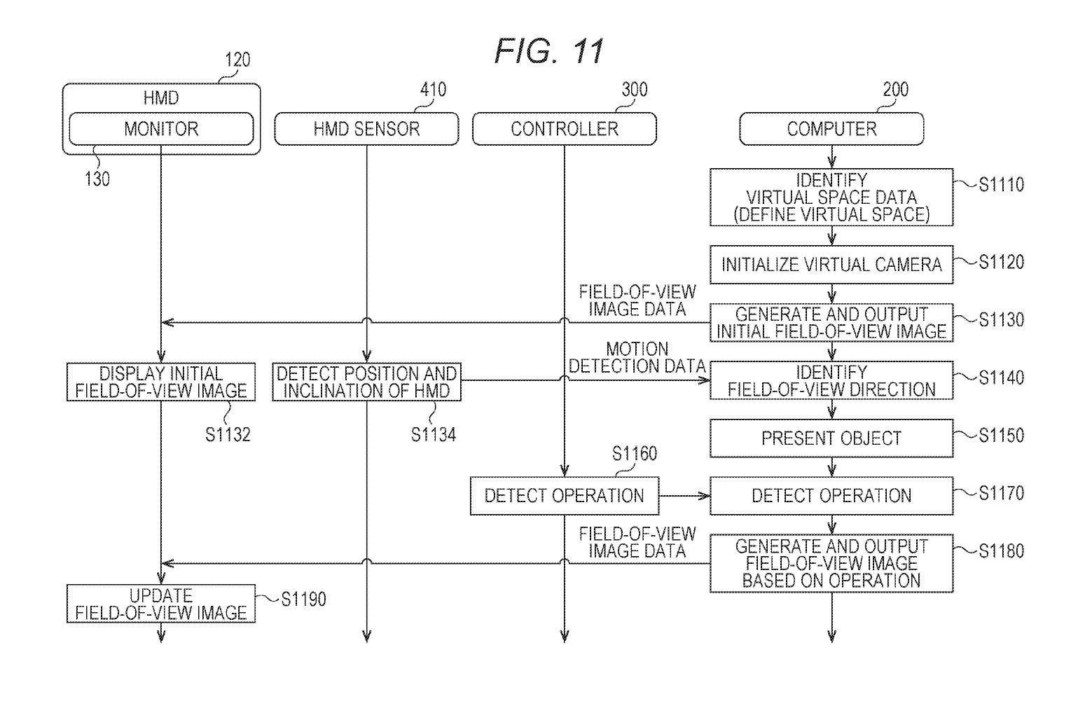

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

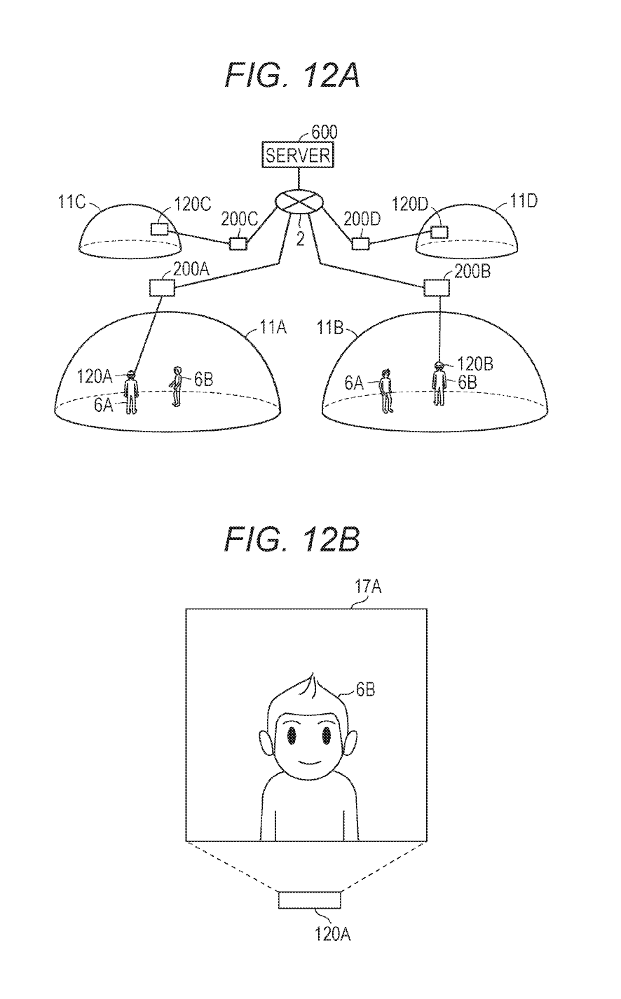

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

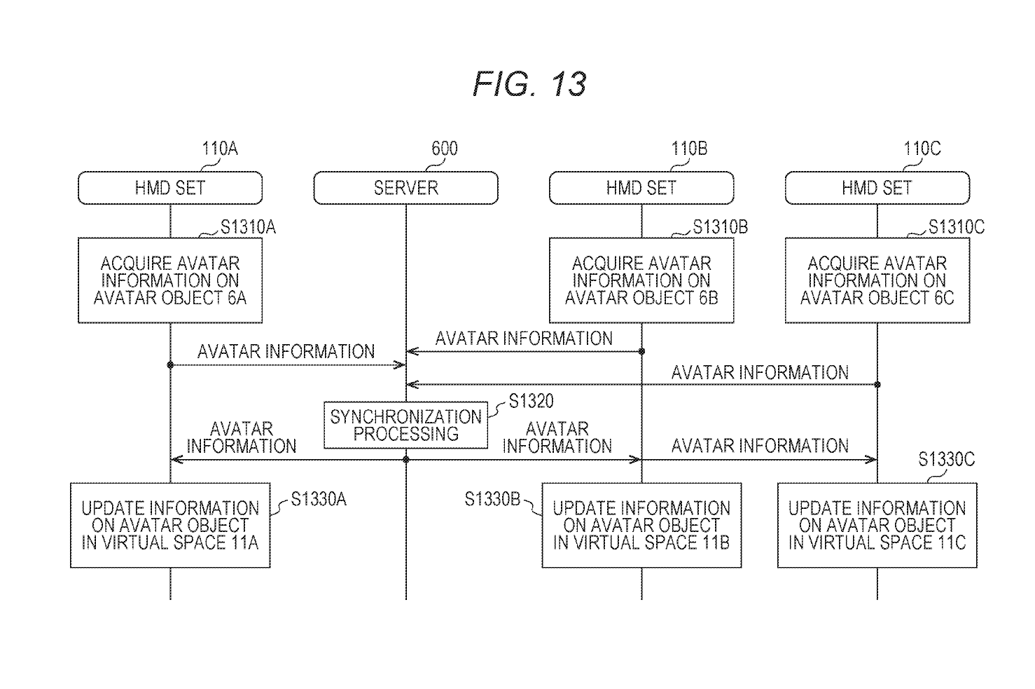

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

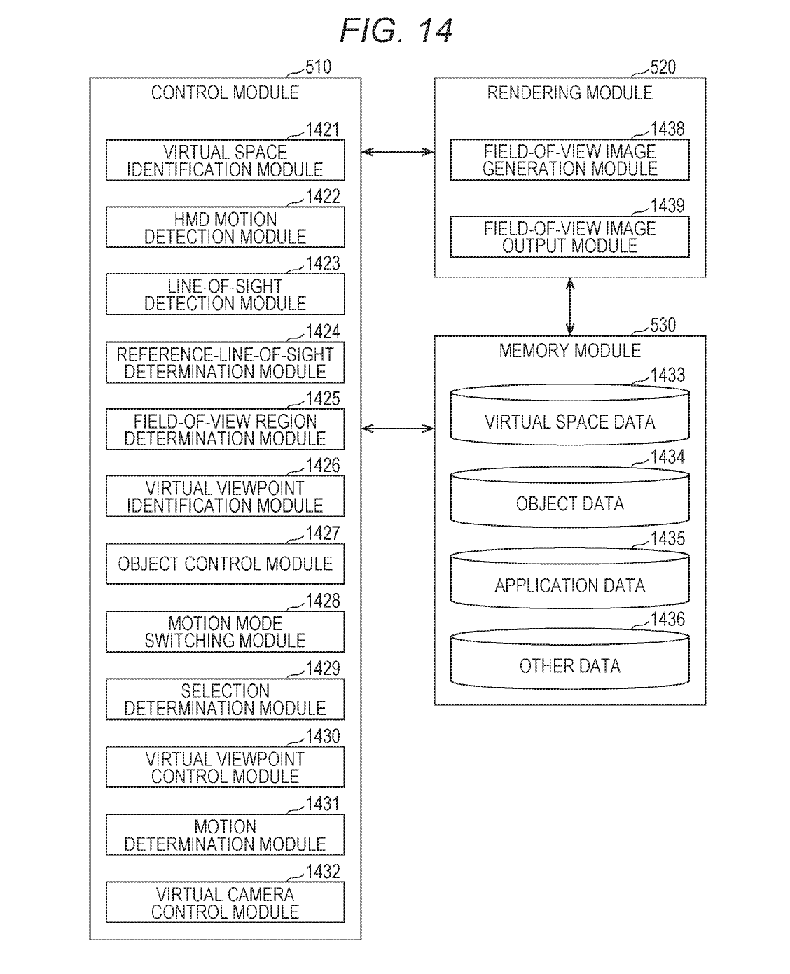

The module configuration of the computer 200 is now described in detail with reference to FIG. 14. FIG. 14 is a block diagram of a detailed configuration of the modules of the computer 200 according to at least one embodiment of this disclosure.

In FIG. 14, the control module 510 includes a virtual space identification module 1421, an HMD motion detection module 1422, a line-of-sight detection module 1423, a reference-line-of-sight determination module 1424, a field-of-view region determination module 1425, a virtual viewpoint identification module 1426, an object control module 1427, a motion mode switching module 1428, a selection determination module 1429, a virtual viewpoint control module 1430, a motion determination module 1431, and a virtual camera control module 1432. The rendering module 520 includes a field-of-view image generation module 1438 and a field-of-view image output module 1439. The memory module 530 includes virtual space data 1433, object data 1434, application data 1435, and other data 1436. The memory module 530 may include various data required for calculations for providing output information corresponding to input from the HMD sensor 410, the motion sensor 420, the eye-gaze sensor 140, the controller 300, and the like to the monitor 130 associated with the HMD 120. The object data 1434 may include data relating to operation objects, target objects, and the like arranged in the virtual space.

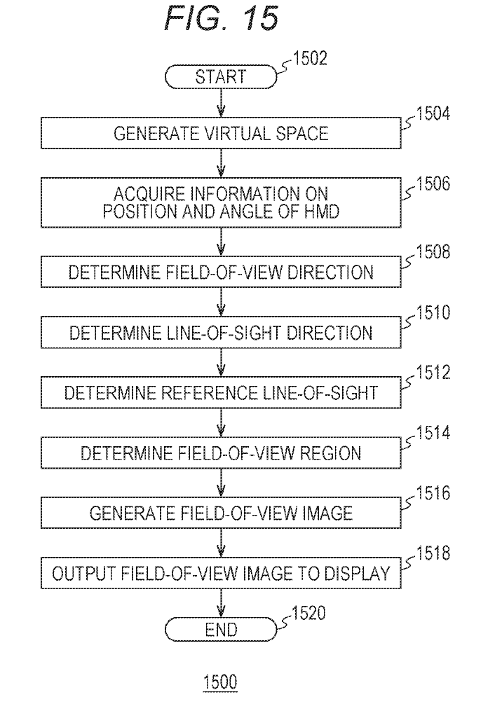

FIG. 15 is a flowchart of general processing for displaying on the monitor 130 an image of the virtual space in which the user is to be immersed according to at least one embodiment of this disclosure.

General processing by the HMD set 110 for providing an image of the virtual space is now described with reference to FIG. 14 and FIG. 15. The virtual space 11 may be provided by interaction among the HMD sensor 410, the eye gaze sensor 140, the computer 200, and the like.

The processing starts at Step 1502. As an example, a game application included in the application data may be executed by the computer 200. In Step 1504, the processor 210 (virtual space identification module 1421) generates a celestial panoramic image 13 forming the virtual space 11 in which the user is to be immersed by, for example, referring to the virtual space data 1433. The position and inclination of the HMD 120 are detected by the HMD sensor 410. The information detected by the HMD sensor 410 is transmitted to the computer 200. In Step 1506, the HMD motion detection module 1422 acquires position information and inclination information on the HMD 120. In Step 1508, a field-of-view direction is determined based on the acquired position information and inclination information.

When the eye gaze sensor 140 detects a motion of the eyeballs of the left and right eyes of the user, information on the motion is transmitted to the computer 200. In Step 1510, the line-of-sight detection module 1423 identifies the direction in which the line of sight of the right eye and the left eye is directed to determine a line-of-sight direction N0. In Step 1012, the reference-line-of-sight determination module 1424 determines the field-of-view direction determined by the inclination of the HMD 120 or the line-of-sight direction N0 of the user as the reference line-of-sight 16. The reference line-of-sight 16 may also be determined based on the position and inclination of the virtual camera 14 following the position and inclination of the HMD 120.

In Step 1514, the field-of-view region determination module 1425 determines the field-of-view region 15 of the virtual camera 14 in the virtual space 11. In FIG. 4, the field-of-view region 15 is a portion forming the field of view of the user in the panorama image 13. The field-of-view region 15 is determined based on reference line-of-sight 16. In FIG. 6 and FIG. 7, which have already been described, there are illustrated a yz cross-sectional view of the field-of-view region 15 viewed from the x direction and an xz cross-sectional view of the field-of-view region 15 viewed from the y direction.

In Step 1516, the field-of-view image generation module 1438 generates a field-of-view image based on the field-of-view region 15. The field-of-view image includes a two-dimensional image for the right eye and a two-dimensional image for the left eye. Those two-dimensional images are superimposed on the monitor 130 (more specifically, the right eye image is output to a right eye display and the left eye image is output to a left eye display), and as a result, the virtual space 11 is provided to the user as a three-dimensional image. In Step 1518, the field-of-view image output module 1439 outputs information on the field-of-view image to the monitor 130. The monitor 130 displays the field-of-view image based on the received information on the field-of-view image. The processing ends at Step 1520.

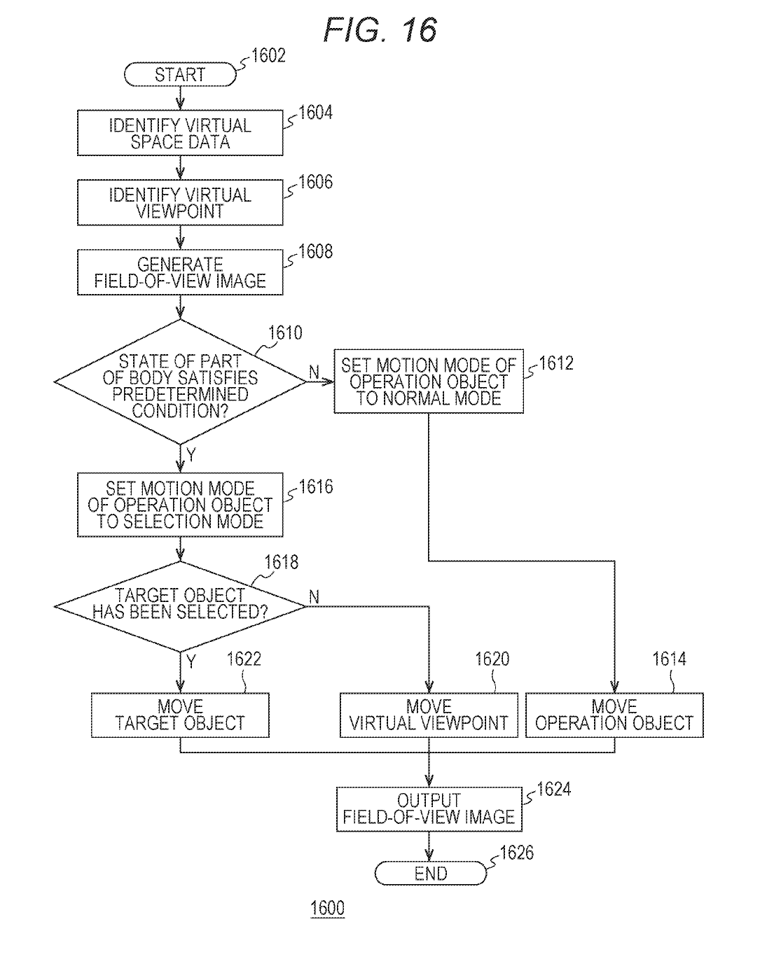

FIG. 16 is a flowchart of a method 1100 according to at least one embodiment of this disclosure. In at least one embodiment of this disclosure, a computer program causes the processor 210 (or computer 200) to execute the steps illustrated in FIG. 16. At least one embodiment of this disclosure is implemented by the processor 210 (or computer 200) executing the method 1600.

In the following, at least one embodiment of this disclosure is specifically described. As a specific example to which at least one embodiment of this disclosure can be applied, there is assumed a game that can be enjoyed by a plurality of users immersing themselves in a virtual space in which the avatar of each user, the game field, the units of each user performing actions in the game field, and the like are arranged. In at least one embodiment, the term “avatar” is synonymous with “avatar object”. However, at least one embodiment of this disclosure is not necessarily limited to such a mode. It is apparent to those skilled in the art that at least one embodiment of this disclosure may take various modes that fall within the scope defined in the appended claims.

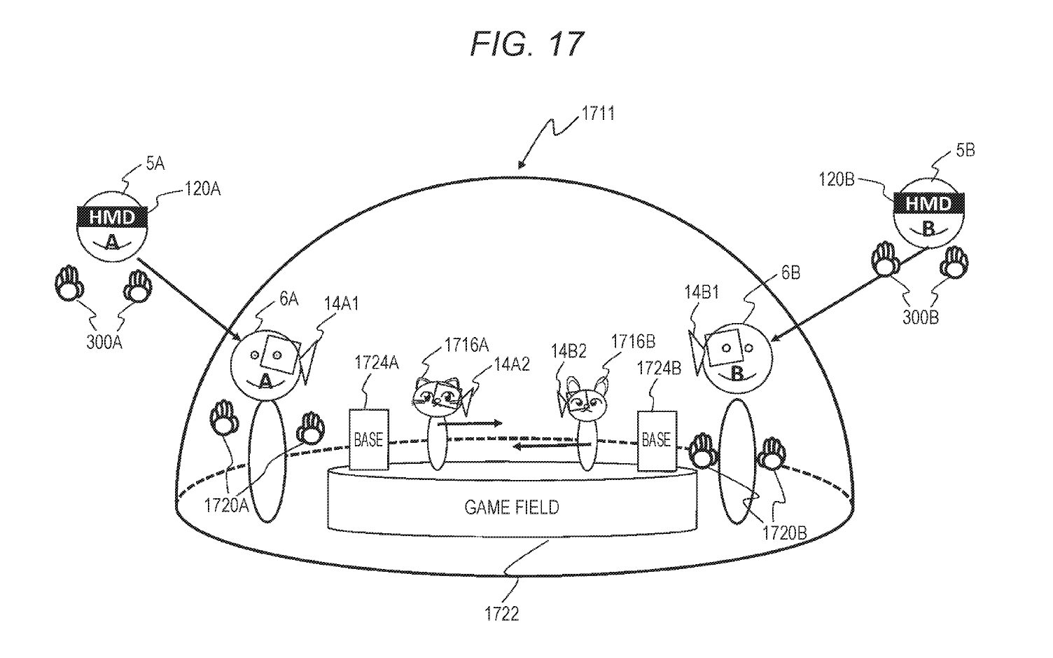

FIG. 17 is a schematic diagram of a mode of a game according to at least one embodiment of this disclosure. In this example, two users 5A and 5B (hereinafter collectively referred to as “user 5”) play the game. The users 5A and 5B wear an HMD 120A and an HMD 120B (hereinafter collectively referred to as “HMD 120”), on their heads, and hold a controller 300A and a controller 300B (hereinafter collectively referred to as “controller 300”), respectively. In one example, the controller 300 has the configuration described above regarding FIG. 8A and FIG. 8B. In this case, each user holds a controller in both hands. However, this is merely an example of the controller 300. Various modes of a controller wearable on other parts of the body of the user may be applied to at least one embodiment of this disclosure.

In a virtual space 1711, there are arranged avatars 6A and 6B (herein after collectively referred to as “avatar 6”) to be operated by the users 5A and 5B, respectively, and a game field 1722. On the game field 1722, there are arranged units 1716A and 1716B (hereinafter collectively referred to as “unit 1716”), bases 1724A and 1724B (hereinafter also collectively referred to as “base 1724”), and the like of the users 5A and 5B, respectively. During game play, the user 5 performs various operations so that his or her unit 1716 can reach the base 1724 of the opponent user.

The user 5 can enjoy, via the avatar 6, the game being played on the game field 1722 in the virtual space 1711. The avatars 6A and 6B have operation objects 1720A and 1720B (hereinafter collectively referred to as “operation object 1720”), respectively. Basically, the operation object 1720 is a part of the body of the avatar 6 corresponding to the part of the body of the user 5 to which the controller 300 is attached. For example, the operation object 1720 is a hand of the avatar 6. This is merely one example of the operation object 1720. The operation object 1720 may be another part of the body of the avatar 6. For example, when the controller 300 is configured to be worn on a foot of the user 5, the operation object 5 may be a foot of the avatar 6.

In FIG. 17, virtual cameras 14A1 and 14B1 (hereinafter collectively referred to as “virtual camera 14-1”) may be arranged at the positions of the avatars 6A and 6B, respectively. Virtual cameras 14A2 and 14B2 (hereinafter collectively referred to as “virtual camera 14-2”) may be arranged at the positions of the units 1716A and 1716B, respectively. The user 5 can view not only an image of the virtual space 1711 obtained by the virtual camera 14-1 (from the viewpoint of the avatar 6), but also an image of the virtual space 1711 obtained by the virtual camera 14-2 (from the viewpoint of the units 1716).

Returning to FIG. 16, the processing starts in Step 1602. The processor 210 reads out and executes the game program included in the application data 1435 stored in the memory 220.

The processing advances to Step 1604, and the virtual space identification module 1421 identifies the virtual space data for the executed game based on the virtual space data 1433, the object data 1434, and the like. The virtual space data defines a virtual space including the operation object 1720 associated with a part (e.g., hand) of the body of the user 5 and at least one target object. The target object may include, in addition to items related to the game, such as cards (described later) to be used in the game, various objects (not shown) such as chairs, shelves, lamps, and the like present in the virtual space 1711. As described later, the operation object 1720 is able to move in at least two motion modes, including a normal mode and a selection mode.

The processing advances to Step 1606, and the virtual viewpoint identification module 1426 identifies the virtual viewpoint in the virtual space 1711. In the example of FIG. 17, the virtual viewpoint may be the position of the virtual camera 14-1 or 14-2. The virtual viewpoint may be appropriately determined in accordance with the progress of the game.

The processing advances to Step 1608, and the field-of-view image generation module 1438 generates a field-of-view image based on the virtual space data, the virtual viewpoint, and the direction of the HMD. The field-of-view image is generated by, for example, the processing already described in association with FIG. 15. The generated field-of-view image is output by the field-of-view image output module 1439 to the monitor 130 associated with the HMD 120, and displayed by the monitor 130. The user 1212 wearing the HMD 120 can see the field-of-view image displayed on the monitor 130.

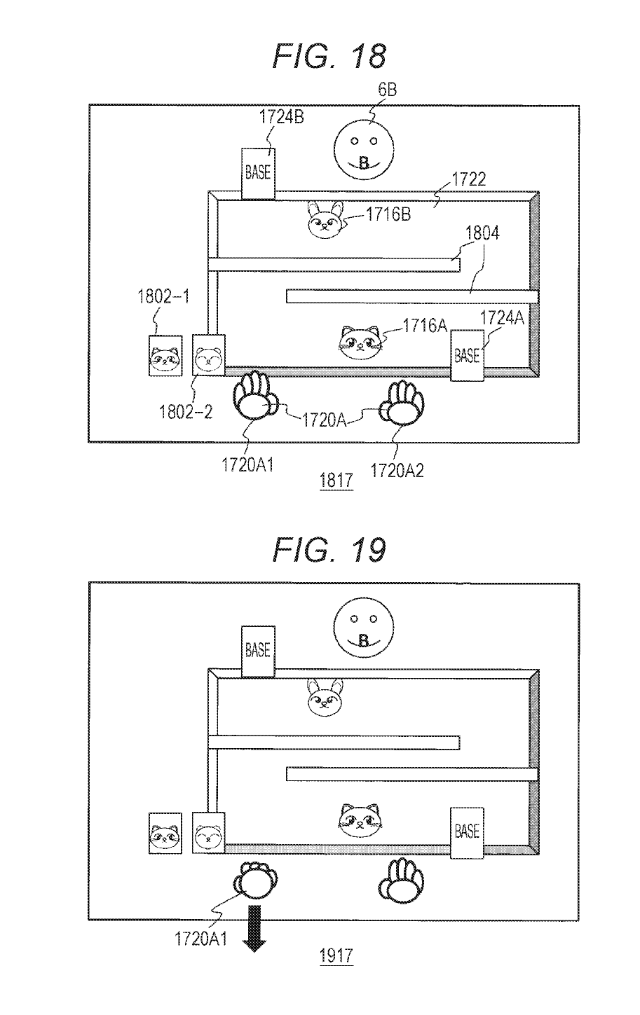

In FIG. 18, there is illustrated an example of a field-of-view image from the viewpoint of the avatar 6 generated by the processing of Step 1608. In this example, the virtual camera 14A1 associated with the avatar 6A is set as the virtual viewpoint. In FIG. 18, the field-of-view image 1817 acquired by the virtual camera 14A1 contains, for example, an operation object (a hand in this example) 1720A of the avatar 6A of the user 5A, an avatar 6B of the opponent user 5B, a game field 1722, units 1716A and 1716B on the game field 1722, bases 1724A and 1724B, walls 1804, items 1802-1 and 1802-2, such as cards possessed by the user 5A, which can be used in the game. In this example, the operation object 1720A includes a left hand object 1720A1 and a right hand object 1720A2. The user 5A can obtain a sense of immersion as if he or she has entered the virtual space 1711 and is participating in the game being played on the game field 1722.

The processing advances to Step 1610, and the motion determination module 1431 determines whether or not the state of a part of the body of the user satisfies a predetermined condition. The predetermined condition can be set in various ways, and may be included in the application data 1435 or the like in the memory 220. For example, the predetermined condition may be that the finger of the user 5A has bent as a result of the user 5A pressing a button (e.g., button 340 and/or 350) of the controller 300A (e.g., controller 300 illustrated in FIG. 8). As another example, the predetermined condition may be that the motion of the user detected by the motion sensor 420 includes a specific motion. In the following, at least one embodiment of this disclosure is described by assuming that the predetermined condition is that the finger of the user 5A has bent as a result of the user 5A pressing a button of the controller 300A with his or her finger.

In at least one embodiment, “motion” of a part of the body of the user may include various concepts, such as the position and direction of that part of the body in a stationary state, the direction of motion in a moving state, the distance of the motion, and the like.

When the predetermined condition is not satisfied (“N” in Step 1610), the processing advances to Step 1612. In at least one embodiment, the operation object 1720A can be operated in at least two modes, including the normal mode and the selection mode. The “normal mode” may simply mean a state in which the operation object 1720A can be moved. Meanwhile, the “selection mode” may mean a state in which the operation object 1720A can be used to have an influence on some object other than the operation object 1720A, for example, by performing a motion of grasping a target object such as the item 1802-1 or 1802-2. The normal mode and selection mode may also be defined in various different ways. Information on the mode of the motion mode may be included in the application data 1435 or the like in the memory 220.

In Step 1612, the motion mode switching module 1428 sets the motion mode of the operation object 1720A to the normal mode. The processing then advances to Step 1614, and the object control module 1427 moves the operation object 1720A in accordance with the motion of the part of the body of the user 5A. The processing then advances to Step 1624, and the field-of-view image output module 1439 outputs a field-of-view image generated by the field-of-view image generation module 1438 to the monitor 130.

When the predetermined condition is satisfied in Step 1610 (“Y” in Step 1610), the processing advances to Step 1616. In Step 1616, the motion mode switching module 1428 sets the motion mode of the operation object 1720A to the selection mode.

FIG. 19 is a diagram of an example of a field-of-view image to be displayed on the monitor 130 by the processing of Step 1616 according to at least one embodiment of this disclosure. When the user 5A presses a button on the left controller of the controller 300A with the left hand finger, it is determined in Step 1610 that the predetermined condition is satisfied, and in Step 1616, the motion mode of the operation object 1720A is set to the selection mode. In this case, in FIG. 19, the object control module 1427 may change the form of the left hand object 1720A1 to a clenched state.

The processing advances to Step 1618, and the selection determination module 1429 determines whether or not a target object has been selected by the operation object 1720A. As an example, when the operation object 1720A enters a range within a predetermined distance from a target object under a state in which the predetermined condition is satisfied, it may be determined that a target object has been selected. It is apparent to those skilled in the art that the determination of whether a target object has been selected may be made in various ways.

When it is determined that a target object is not selected (“N” in Step 1618), the processing advances to Step 1620. In Step 1620, the virtual viewpoint control module 1430 moves, during continuation of the selection mode, the virtual viewpoint (e.g., position of virtual camera 14A1) based on the motion of the part of the body of the user 5A or the motion of the operation object 1720A. The processing then advances to Step 1624, and the field-of-view image output module 1439 outputs a field-of-view image generated based on the motion of the virtual viewpoint to the monitor 130.

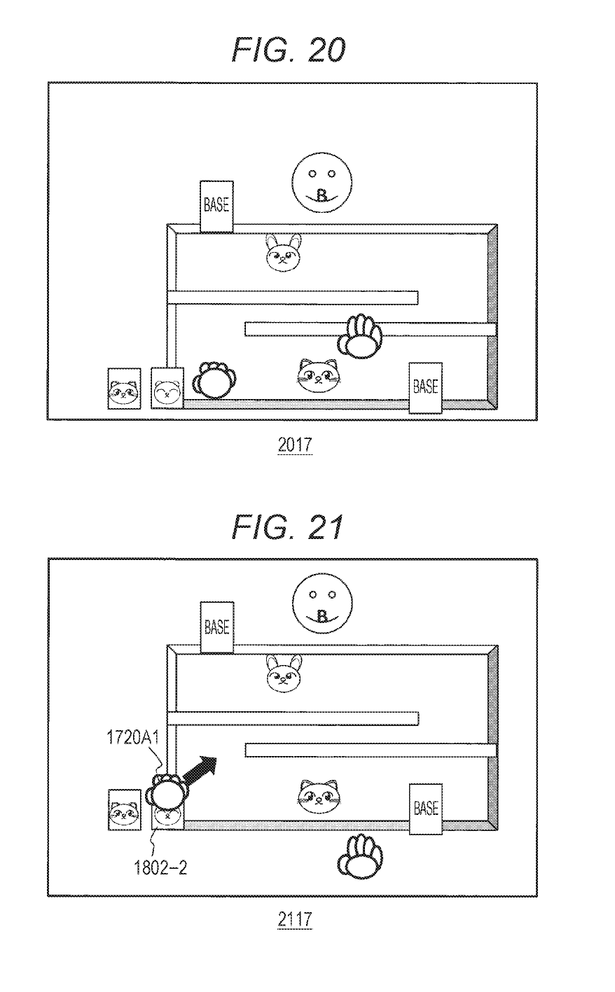

FIG. 20 is a diagram of an example of a field-of-view image to be displayed on the monitor 130 by the processing of Step 1618 and Step 1620 according to at least one embodiment of this disclosure. During continuation of the selection mode, when the user 5A pulls his or her left hand in a backward direction when the target object is not selected, the motion sensor 420 detects this motion. The object control module 1427 moves, based on the detected motion, the left hand object 1720A1 backward, as indicated by the arrow in FIG. 19. The virtual viewpoint control module 1430 moves the virtual viewpoint in a predetermined manner based on the motion of the left hand of the user 5A or the motion of the left hand object 1720A1. For example, the virtual viewpoint control module 1430 may move the virtual viewpoint forward in response to the backward movement of the left hand or the left hand object 1720A1. In this case, a field-of-view image 2017 illustrated in FIG. 20 is generated based on the virtual viewpoint that has been moved forward. In at least one embodiment, it is possible to provide the user with a virtual experience in which he or she is capable of freely moving in the virtual space 1711 based on the motion of a part of his or her own body.

Returning to FIG. 16, when it is determined in Step 1618 that a target object has been selected (“Y” in Step 1618), the processing advances to Step 1622. In Step 1622, the virtual viewpoint control module 1430 moves, during continuation of the selection mode, the selected target object based on the motion of the part of the body of the user 5A or the motion of the operation object 1720A. The processing then advances to Step 1624, and the field-of-view image output module 1439 outputs a field-of-view image generated based on the motion of the virtual viewpoint to the monitor 130.

FIG. 21 is a diagram of an example of a field-of-view image to be displayed on the monitor 130 when it is determined that a target object has been selected according to at least one embodiment of this disclosure. During continuation of the selection mode, when the user moves his or her left hand such that the left hand object 1720A1 overlaps the card 1802-2, the motion sensor 420 detects this motion. The object control module 1427 causes, based on the detected motion, the left hand object 1720A1 to grasp the card 1802-2, as illustrated in FIG. 21. As a result, a field-of-view image 2117 is displayed on the monitor 130.

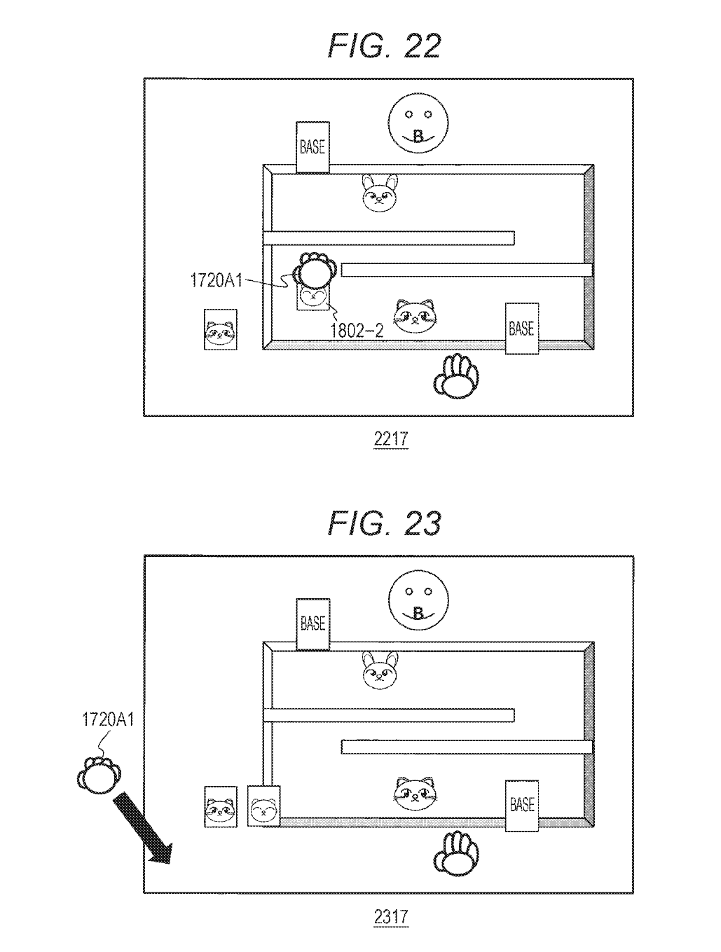

FIG. 22 is a diagram of an example of a field-of-view image to be displayed on the monitor 130 by the processing of Step 1622. When the user 5A moves his or her left hand obliquely forward to the right, the motion sensor 420 detects this motion. The object control module 1427 moves, based on the detected motion, the left hand object 1720A1 and the target object 1802-2 in the manner indicated by the arrow in FIG. 21. At this time, the virtual viewpoint control module 1430 may not move the virtual viewpoint at all or may move the virtual viewpoint somewhat. As a result, a field-of-view image 2217 illustrated in FIG. 22 is generated and displayed on the monitor 130.

FIG. 23 is a schematic diagram of an example of the processing in Step 1620 according to at least one embodiment of this disclosure. In this example, the motion of the left hand of the user 5A or the motion of the left hand object 1720A1 corresponding to that left hand extends across the outside and the inside of the visual field, as indicated by the arrow. Thus, when the angle of the motion of the part of the body of the user or the motion of the operation object relative to the roll axis of the visual field is more than half of the viewing angle, the virtual viewpoint control module 1430 may set the movement speed of the virtual viewpoint to zero or reduce the movement speed of the virtual viewpoint such that the movement speed is lower than when the motion is performed within the visual field. As a result, it is possible to avoid a viewpoint movement that is difficult for the brain of the user 5A wearing the HMD 120A to predict, enabling motion sickness of the user 5A to be prevented. For the same purpose, the virtual viewpoint control module 1430 may reduce, or set to zero, based on at least one component of a direction orthogonal to the roll axis of the visual field among the motion of the part of the body of the user or the motion of the operation object, a component in that direction of the movement speed of the virtual viewpoint. For example, the processor 210 may break down the size of the motion of the left hand object 1720A1 based on the motion of the left hand of the user 5A detected by the motion sensor 420 into a pitch direction component, a yaw direction component, and a roll direction component. The virtual viewpoint control module 1430 may, based on the motion of the pitch direction component and the yaw direction component, set to zero, or reduce to less than the actual size, the components in those directions of the movement speed of the virtual viewpoint.

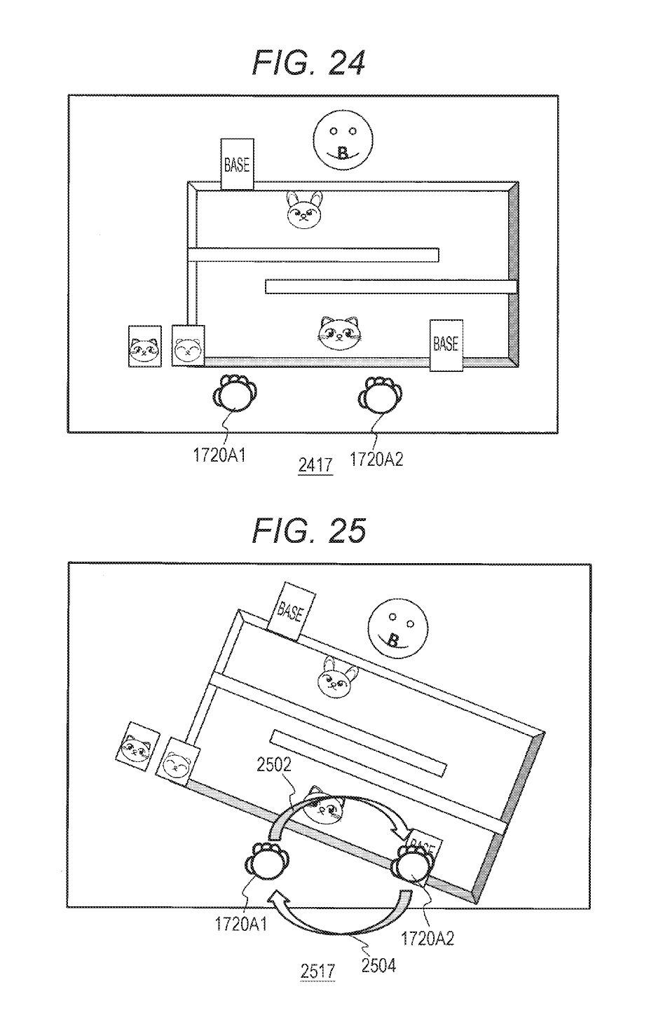

FIG. 24 is a schematic diagram of an example of the processing in Step 1620 according to at least one embodiment of this disclosure. In this example, when the user 5A presses a predetermined button on both the right controller and the left controller held in his or her right hand and left hand, respectively, the motion modes of both the left hand object 1720A1 and the right hand object 1720A2 are set to the selection mode. In this state, when the motion of the right hand and the left hand is detected by the motion sensor 420, the virtual viewpoint control module 1430 may move the virtual viewpoint based on the motion of the hand that has moved first among the right hand and the left hand or the motion of the operation object corresponding to the hand that has moved first.

In Step 1620, the virtual viewpoint control module 1430 may also move the virtual viewpoint in various ways other than the example described above. In one example, in the selection mode, the virtual viewpoint control module 1430 may gradually increase the movement speed of the virtual viewpoint when a continuous motion of the part of the body of the user or the operation object is detected. In this example, the motion determination module 1431 may determine that a continuous motion has been performed when, after a certain motion is detected, the next motion is detected within a predetermined time. The motion determination module 1431 may also determine that a continuous motion has been performed when a predetermined number of motions or more are detected within a predetermined time.

In another example, the virtual viewpoint control module 1430 may set a movement speed of the virtual viewpoint corresponding to one motion included in the continuous motion described above to be faster than a movement speed of the virtual viewpoint corresponding to a motion performed before the one motion.

In another example, the virtual viewpoint control module 1430 may increase the movement speed of the virtual viewpoint when the motion included in the continuous motion is a motion at a constant speed or higher and/or when a plurality of motions included in the continuous motion are performed within a time interval smaller than a fixed time interval.

In another example, the virtual viewpoint control module 1430 may gradually increase, when one motion included in the continuous motion is a motion at a constant speed or higher and/or a motion of a certain distance or further, the movement speed of the virtual viewpoint during a period in which the one motion is being performed.

FIG. 25 is a schematic diagram of an example of the processing in Step 1620 according to at least one embodiment of this disclosure. When the user 5A presses a predetermined button on both the right controller and the left controller, the motion mode of each of the left hand object 1720A1 and the right hand object 1720A2 is set to the selection mode. When a motion is detected in which the right hand and the left hand both enclose a similarly shaped region in a similar direction without selecting a target object, as indicated by arrows 2502 and 2504, the virtual viewpoint control module 1430 may rotate the virtual viewpoint based on the motion. In this case, the “similar shape” may be a circle, an ellipse, or a variety of other shapes. As a result of the rotation of the virtual viewpoint, a field-of-view image 2517 is generated and displayed on the monitor 130.

In the example illustrated in FIG. 25, when the motion enclosing a similarly shaped region is inclined with respect to the horizontal plane, the processor 210 may project the motion onto the horizontal plane. The virtual viewpoint control module 1430 may also rotate the virtual viewpoint based on the motion projected onto the horizontal plane.

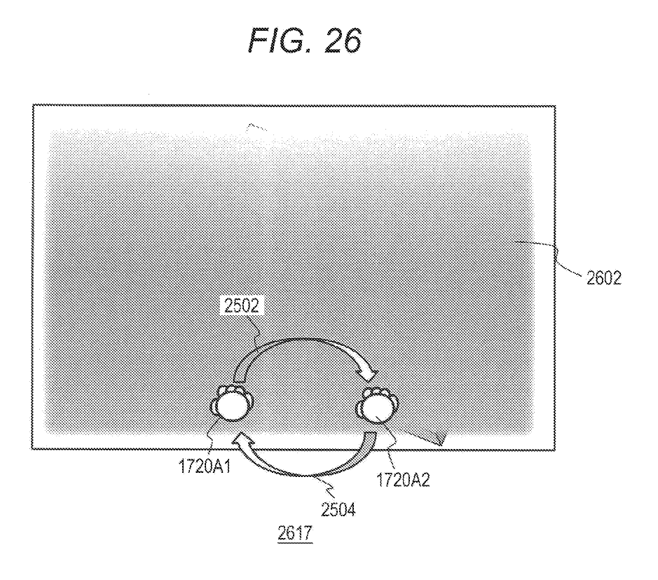

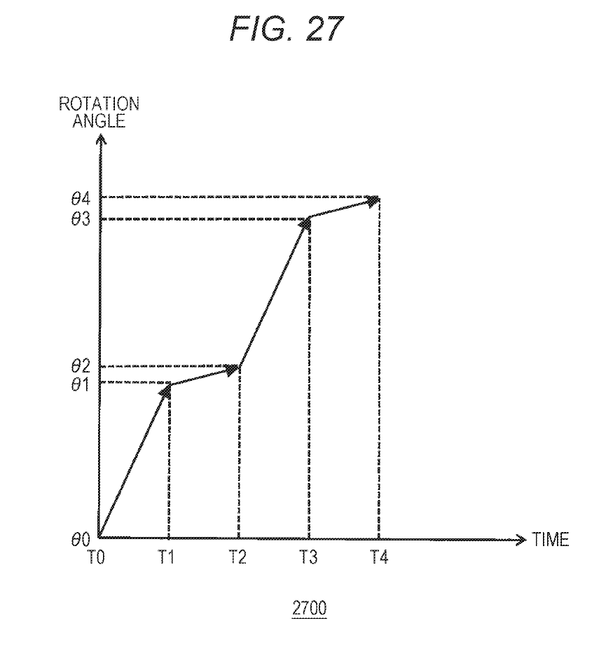

In the example illustrated in FIG. 25, the field-of-view image generation module 1438 may reduce visual information on the field-of-view image by performing blurring processing or the like when the virtual viewpoint is rotated. FIG. 26 is a diagram of an example of a field-of-view image 2617 in which the visual information is reduced according to at least one embodiment of this disclosure. This blurring processing enables a reduction in an effect causing the user to suffer from motion sickness during rotation of the virtual viewpoint.

In the example illustrated in FIG. 25, it is not required for the virtual viewpoint control module 1430 to rotate the virtual viewpoint at a constant speed. For example, the rotation of the virtual viewpoint may be a combination of a rotation at a first speed and a rotation at a second speed, which is slower than the first speed, or is zero. FIG. 27 is a graph of an example of a relationship between the rotation angle of the virtual viewpoint and time. In FIG. 27, the virtual viewpoint control module 1430 may rotate the virtual viewpoint by a large amount from an angle 80 to an angle 81 during a time interval from T0 to T1, rotate by a small amount from the angle 81 to an angle 82 during a next time interval from T1 to T2, and then alternately repeat those rotations. The virtual viewpoint may also be rotated in various other ways. With such an embodiment, compared with a case in which the virtual viewpoint is rotated at a constant speed, it is possible to obtain an effect in which the user is less likely to suffer from motion sickness.

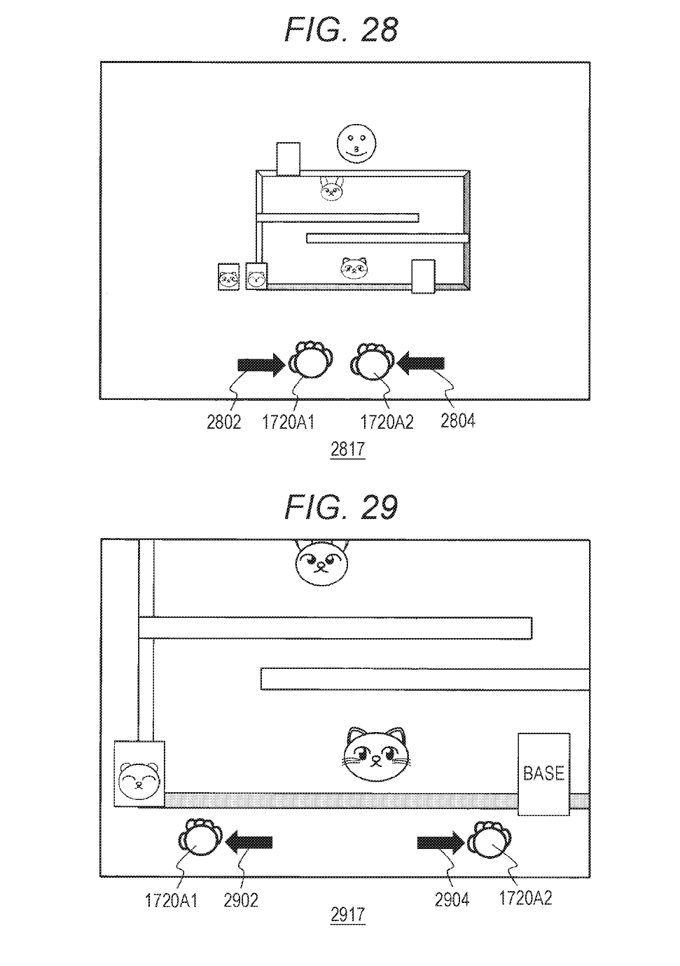

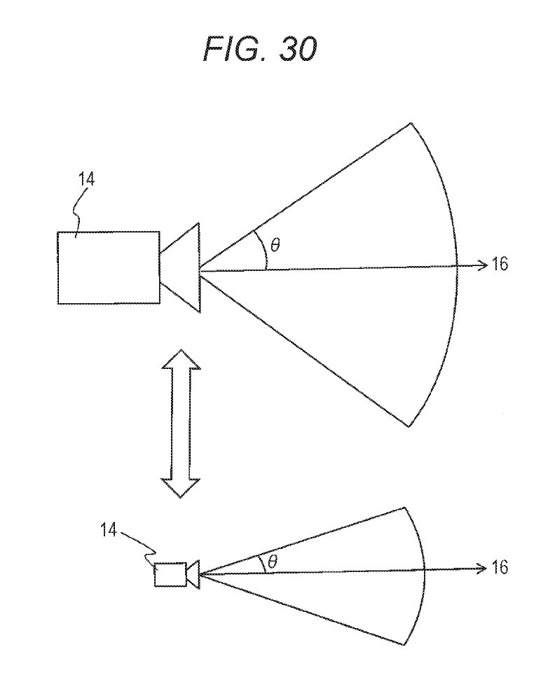

FIG. 28 is a schematic diagram of an example of the processing in Step 1620 according to at least one embodiment of this disclosure. When the user 5A presses a predetermined button on both the right controller and the left controller, the motion modes of both the left hand object 1720A1 and the right hand object 1720A2 are set to the selection mode. When a motion is detected in which the right hand and the left hand are approaching each other without selecting the target object, the virtual viewpoint control module 1430 may reduce or increase the range of the virtual space contained in the field-of-view image. In order to implement this, for example, in FIG. 30, the virtual viewpoint control module 1430 may change the size of the virtual camera 14 in the virtual space 1711. For example, when a motion is detected in which the right hand and the left hand are approaching each other, the virtual viewpoint control module 1430 may enlarge the size of the virtual camera 14 as illustrated in the upper part of FIG. 30. Through enlarging the size of the virtual camera 14, the visual field capable of being photographed by the virtual camera 14 is enlarged. A field-of-view image 2817 of FIG. 28 is an example of the field-of-view image generated in this case. Compared with the field-of-view image 2417, for example, illustrated in FIG. 24, it can be seen that the range of the virtual space contained in the field-of-view image is larger. As another example, when a motion is detected in which the right hand and the left hand are approaching each other, the virtual viewpoint control module 1430 may reduce the size of the virtual camera 14 as illustrated in the lower part of FIG. 30. In this case, the visual field capable of being photographed by the virtual camera 14 is reduced, and the range of the virtual space contained in the field-of-view image is smaller.

FIG. 29 is a schematic diagram of an example of the processing in Step 1620 according to at least one embodiment of this disclosure. In contrast to the example of FIG. 28, when a motion is detected in which the right hand and the left hand are moving away from each other, the virtual viewpoint control module 1430 may reduce or increase the range of the virtual space contained in the field-of-view image. The specific processing is the same as in the case of FIG. 28. As an example, the virtual viewpoint control module 1430 may reduce or enlarge the size of the virtual camera 14. A field-of-view image 2917 is an example of the field-of-view image generated when the size of the virtual camera 14 is reduced. Compared with the field-of-view image 2917 illustrated in FIG. 24, for example, it can be seen that the range of the virtual space contained in the field-of-view image is smaller.

In the examples illustrated in FIG. 28 and FIG. 29, the virtual viewpoint control module 1430 may change the range of the virtual space contained in the field-of-view image by a method other than enlarging or reducing the size of the virtual camera 14. For example, when the virtual camera 14 includes a right eye virtual camera and a left eye virtual camera, the virtual viewpoint control module 1430 may increase or reduce the distance between the right eye virtual camera and the left eye virtual camera. Increasing the distance between the right eye virtual camera and the left eye virtual camera enables the range of the virtual space contained in the field-of-view image to be enlarged. Meanwhile, reducing the distance between the right eye virtual camera and the left eye virtual camera enables the range of the virtual space contained in the field-of-view image to be reduced.

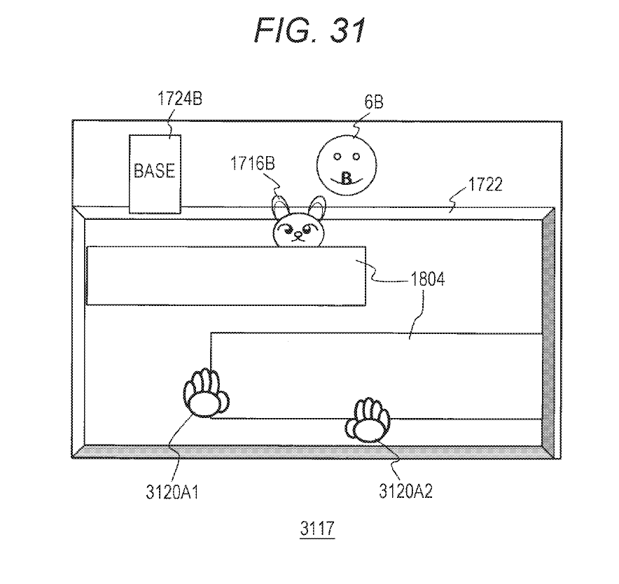

FIG. 31 is a diagram of an example of a field-of-view image generated by the processing of Step 1608 according to at least one embodiment of this disclosure. In this example, the user 5A sets the virtual camera 14A2 associated with the unit 1716A as the virtual viewpoint by performing a predetermined operation in the game. In FIG. 31, a field-of-view image 3117 acquired by the virtual camera 14A2 contains operation objects (in this case, both hands) 3120A1 and 3120A2 of the unit 1716A, the avatar 6B of the opponent user, the unit 1716B of the opponent user, the game field 1722, the base 1724B of the opponent user, the walls 1804, and the like. In this way, in at least one embodiment, the user 5A can not only enjoy a virtual experience in the virtual space from the viewpoint of the avatar 6A, but can also enjoy a virtual experience from the viewpoint of the unit 1716A advancing toward the base 1724B of the opponent on the game field 1722. In the case of FIG. 31 as well, the processing according to at least one embodiment of this disclosure described with reference to FIG. 16 to FIG. 30 can be applied. Specifically, the user 5A can operate the left hand object 3120A1 and the right hand object 3120A22 of the unit 1716A based on the motion of a part of his or her own body. When the virtual viewpoint moves based on the processing of Step 1620, the user 5A can experience moving on the game field 1722 to the base 1724B of the opponent (e.g., by creeping forward) as the unit 1716A. Therefore, according to at least one embodiment of this disclosure, it is possible to provide the user with a highly entertaining virtual experience in the virtual space.

Embodiments of this disclosure have been described primarily as being implemented as the processor 210 (or computer 200) or the method 1600. However, it is apparent to those skilled in the art that the embodiments of this disclosure may be implemented as a computer program for executing the method 1600 on the processor 210.

Although embodiments of this disclosure have been described, it is to be understood that those are merely an example and are not intended to limit the scope of this disclosure. It should be understood that changes, additions, improvements, and the like of the embodiments may be made as appropriate without departing from the spirit and scope of this disclosure. The scope of this disclosure should not be limited by any one of the embodiments described above but should be defined only by the appended claims and their equivalents.

What is claimed is:

1. A method, comprising:
defining a virtual space, wherein the virtual space comprises a virtual viewpoint, an operation object, and a target object;
defining a visual field in the virtual space in accordance with a position of the virtual viewpoint in the virtual space;
generating a visual-field image corresponding to the visual field;
displaying the visual-field image on the HMD;
detecting a position of a part of a body of a user associated with the HMD;
determining that a state of the part of the body satisfies a first condition;
determining, on condition that the first condition is satisfied, that a state of the part of the body satisfies a second condition different from the first condition, the second condition comprising a condition that the operation object has yet to select the target object;
setting, in accordance with the first condition being satisfied and the second condition failing to be satisfied, a motion of the operation object to a first mode;
setting, in accordance with the first condition being satisfied and the second condition being satisfied, the motion of the operation object to a second mode;
moving, on condition that the first mode is set, the operation object in the virtual space in accordance with a motion of the part of the body without changing a state of the virtual viewpoint in the virtual space;
moving, on condition that the second mode is set, the operation object in the virtual space in accordance with the motion of the part of the body, and changing the state of the virtual viewpoint in the virtual space in accordance with the motion of the part of the body or a motion of the operation object; and
updating the visual-field image in accordance with the state of the virtual viewpoint having been changed.

2. The method according to claim 1, further comprising moving, on condition that the first mode is set, the operation object and the target object selected by the operation object in the virtual space in accordance with the motion of the part of the body.

3. The method according to claim 1, further comprising:
detecting that the part of the body has been moved in a first direction in a real space under a state in which the second mode is set; and
identifying a second direction in the virtual space corresponding to the first direction,
wherein the changing of the state of the virtual viewpoint in the virtual space comprises bringing the virtual viewpoint closer to the operation object by moving the virtual viewpoint in a direction opposite to the second direction.

4. The method according to claim 1,
wherein the part of the body comprises a right hand and a left hand of the user,
wherein the operation object comprises a right hand object and a left hand object,
wherein the method further comprises:
moving the right hand object in accordance with a motion of the right hand; and
moving the left hand object in accordance with a motion of the left hand, and
wherein the first condition comprises at least one of the right hand or the left hand being gripped, or at least one of the right hand object or the right hand object being gripped.

5. The method according to claim 4, further comprising:
detecting that both the right hand and the left hand are gripped or that both the right hand object and the left hand object are gripped;
detecting which of the right hand and the left hand has started to move first, or identifying which of the right hand object and the left hand object has started to move first; and
changing the state of the virtual viewpoint in the virtual space in accordance with the motion of the part of the body that has started to move first or the motion of the operation object that has started to move first.

6. The method according to claim 1,
wherein the changing of the state of the virtual viewpoint comprises moving the position of the virtual viewpoint in the virtual space, and
wherein the method further comprises:
detecting a duration during which the operation object is continuously moved under the state in which the second mode is set;
detecting that the duration exceeds a first threshold;
setting, in accordance with the duration being equal to or less than the first threshold, a movement speed of the virtual viewpoint to a first speed corresponding to a movement speed of the operation object; and
setting, in accordance with the duration exceeding the first threshold, the movement speed of the virtual viewpoint to a second speed faster than the first speed.

9. The method according to claim 1,
wherein the changing of the state of the virtual viewpoint comprises moving the position of the virtual viewpoint in the virtual space, and
wherein the method further comprises:
detecting a movement speed at a time when the operation object is moved under the state in which the second mode is set;
detecting that the duration exceeds a second threshold;
setting, in accordance with the duration being equal to or less than the second threshold, a movement speed of the virtual viewpoint to a first speed corresponding to the movement speed of the operation object; and
setting, in accordance with the duration exceeding the second threshold, the movement speed of the virtual viewpoint to a second speed faster than the first speed.

10. The method according to claim 1,
wherein the changing of the state of the virtual viewpoint comprises moving the position of the virtual viewpoint in the virtual space, and
wherein the method further comprises:
detecting a movement distance at a time when the operation object is moved under the state in which the second mode is set;
detecting that the duration exceeds a third threshold;
setting, in accordance with the duration being equal to or less than the third threshold, a movement speed of the virtual viewpoint to a first speed corresponding to the movement speed of the operation object; and
setting, in accordance with the duration exceeding the third threshold, the movement speed of the virtual viewpoint to a second speed faster than the first speed.

11. The method according to claim 1,
wherein the changing of the state of the virtual viewpoint comprises moving the position of the virtual viewpoint in the virtual space, and
wherein the method further comprises:
detecting that the second mode has been released after the operation object is moved under the state in which the second mode is set;
detecting that the operation object has yet to be moved for a predetermined time under a state in which the second mode is set;
subsequently detecting that the operation object has been moved under a state in which the second mode is set; and
setting, in accordance with the predetermined time being less than a fourth threshold, a movement speed of the virtual viewpoint to a second speed faster than the first speed.

12. The method according to claim 1,
wherein the defining of the visual field in the virtual space comprises:
defining a visual axis in the virtual space;
defining a viewing angle in the virtual space; and
defining the visual field in accordance with the position of the virtual viewpoint in the virtual space, the visual axis, and the viewing angle, and
wherein the method further comprises:
detecting that the part of the body has been moved in a first direction in a real space under a state in which the second mode is set;
identifying a second direction in the virtual space corresponding to the first direction; and
reducing a speed at which the state of the virtual viewpoint is changed in accordance with an angle formed between the second direction and the visual axis being more than half of the viewing angle.

13. The method according to claim 1,
wherein the defining of the visual field in the virtual space comprises:
defining a visual axis in the virtual space;
defining a viewing angle in the virtual space; and
defining the visual field in accordance with the position of the virtual viewpoint in the virtual space, the visual axis, and the viewing angle,
wherein the method further comprises:
detecting that the part of the body has been moved in a first direction in a real space under a state in which the second mode is set;
identifying a second direction in the virtual space corresponding to the first direction; and
identifying a third direction in which, of the second direction, a component of a direction orthogonal to the visual axis is reduced, and
wherein the changing of the state of the virtual viewpoint comprises moving the position of the virtual viewpoint in the virtual space in a direction opposite to the third direction.

12. The method according to claim 1,
wherein the part of the body comprises a right hand and a left hand of the user,
wherein the operation object comprises a right hand object and a left hand object, and
wherein the method further comprises:
moving the right hand object in accordance with a motion of the right hand;
moving the left hand object in accordance with a motion of the left hand;
satisfying the first condition and the second condition by the right hand and the right hand object;
satisfying the first condition and the second condition by the left hand and the left hand object;
detecting a shared rotational movement about a predetermined axis based on a motion of both the right hand and the left hand, or a motion of both the right hand object and the left hand object; and
rotating the virtual viewpoint in the virtual space in accordance with the shared rotational movement.

13. The method according to claim 12, wherein the rotating of the virtual viewpoint comprises rotating the virtual viewpoint at a second speed and rotating the virtual viewpoint at a first speed, which is slower than the second speed or, is zero.

14. The method according to claim 1,
wherein the part of the body comprises a right hand and a left hand of the user,
wherein the operation object comprises a right hand object and a left hand object, and
wherein the method further comprises:
moving the right hand object in accordance with a motion of the right hand;
moving the left hand object in accordance with a motion of the left hand;
satisfying the first condition and the second condition by the right hand and the right hand object;
satisfying the first condition and the second condition by the left hand and the left hand object; and
enlarging the virtual visual field in accordance with a reduction in a distance between the right hand and the left hand or a reduction in a distance between the right hand object and the left hand object.

15. The method according to claim 14, wherein the enlarging of the virtual visual field comprises enlarging the virtual visual field without changing the position of the virtual viewpoint in the virtual space.
